(19) United States
(12) Patent Application Publication
(10) Pub. No.: US 2016/0293015 A1
(43) Pub. Date: Oct. 6, 2016

(54) PROJECTILE LAUNCHED UAV RECONNAISSANCE SYSTEM AND METHOD

(71) Applicant: Oleksiy Bragin, Moscow (RU)

(72) Inventor: Oleksiy Bragin, Moscow (RU)

(21) Appl. No.: 14/106,733

(22) Filed: Dec. 14, 2013

(51) Int. Cl. G08G 5/00; G05D 1/12; B64C 39/02

(52) U.S. Cl. CPC G08G 5/0034; B64C 39/024; G05D 1/12; B64C 2201/141; B64C 2201/08; B64C 2201/12; B64C 2201/108; B64C 2201/102

(57) ABSTRACT

A method, system and computer readable medium for projectile launched UAV reconnaissance/surveillance are described. The method can include determining a designated target. The method can also include estimating a distance and trajectory from a launch point to the target and communicating distance and trajectory information to a launcher, a projectile and a communication and control system. The method can also include firing a separation charge when the UAV projectile reaches a predetermined point along the flight path, the separation charge being configured to separate a UAV from a projectile casing. The method can further include deploying the UAV and activating a propulsion system of the UAV and obtaining signals via one or more sensors.

### FIELD

Embodiments relate generally to unmanned aerial vehicles (UAVs), and more particularly, to projectile launched UAV reconnaissance systems, methods and computer readable media.

### BACKGROUND

In some situations (e.g., combat zones, hazardous facilities and the like), personnel may benefit from obtaining reconnaissance and/or surveillance data to assess a situation or gather intelligence. It may not be suitable in some situation to launch and pilot a conventional UAV into a zone where surveillance is desired. Also, in some situations obstructions may prevent a conventional UAV from entering the zone for surveillance.

Embodiments were conceived in light of the above-mentioned problems and limitations, among other things.

### SUMMARY

An embodiment can include a method for a projectile launched UAV system. The method can include determining a designated target for unmanned aerial vehicle (UAV) reconnaissance. The method can also include estimating a distance and trajectory from a launch point to the target and communicating distance and trajectory information to a launcher, a projectile and a communication and control system. The method can further include receiving an indication that UAV projectile launch has occurred and determining a position and a velocity of the UAV projectile along a flight path from the launch point to the target. The method can also include firing (or initiating) a separation charge when the UAV projectile reaches a predetermined point along the flight path, the separation charge being configured to separate a UAV from a projectile casing. The method can further include deploying the UAV and activating a propulsion system of the UAV and obtaining signals via one or more sensors. The method can also include transmitting the signals to an external system.

The method can also include receiving obstacle information about one or more obstacles between the launch point and the target. The method can further include determining flight conditions including one or more of temperature, humidity, and wind speed and direction. The method can also include adjusting flight controls to compensate for a course deviation.

The method can further include detonating an explosive charge in the projectile casing when the casing contacts an obstacle. The method can also include detonating an explosive charge in the projectile casing at a predetermined time after firing the separation charge. Designating the target can include includes one or more of designating the target via a laser, designating the target with a signal, and receiving coordinates for the target. The method can also include comprising relaying a signal from another UAV to a communication and control system.

Some implementations can include a system comprising a processor coupled to a computer readable medium, the computer readable medium having stored thereon software instructions that, when executed by the processor, cause the processor to perform a series of operations. The operations can include determining a designated target for unmanned aerial vehicle (UAV) reconnaissance and estimating a distance and trajectory from a launch point to the target. The operations can also include communicating distance and trajectory information to a launcher, a projectile and a communication and control system, and receiving an indication that UAV projectile launch has occurred. The operations can further include determining a position and a velocity of the UAV projectile along a flight path from the launch point to the target, and firing a separation charge when the UAV projectile reaches a predetermined point along the flight path, the separation charge being configured to separate a UAV from a projectile casing.

The operations can also include deploying the UAV and activating a propulsion system of the UAV and obtaining signals via one or more sensors. The operations can further include transmitting the signals to an external system. The operations can further include receiving obstacle information about one or more obstacles between the launch point and the target.

The operations can further include determining flight conditions including one or more of temperature, humidity, and wind speed and direction. The operations can also include adjusting flight controls to compensate for a course deviation.

The operations can further include detonating an explosive charge in the projectile casing when the casing contacts an obstacle. The operations can also include detonating an explosive charge in the projectile casing at a predetermined time after firing the separation charge. Designating the target can include one or more of designating the target via a laser, designating the target with a signal, and receiving coordinates for the target. The operations can further include relaying a signal from another UAV to a communication and control system.

Some implementations can include a nontransitory computer readable medium having stored thereon software instructions that, when executed by a processor, cause the processor to perform a series of operations. The operations can include determining a designated target for unmanned aerial vehicle (UAV) reconnaissance, and estimating a distance and trajectory from a launch point to the target. The operations can also include communicating distance and trajectory information to a launcher, a projectile and a communication and control system, and receiving an indication that UAV projectile launch has occurred. The operations can further include determining a position and a velocity of the UAV projectile along a flight path from the launch point to the target, and firing a separation charge when the UAV projectile reaches a predetermined point along the flight path, the separation charge being configured to separate a UAV from a projectile casing. The operations can also include deploying the UAV and activating a propulsion system of the UAV and obtaining signals via one or more sensors. The operations can further include transmitting the signals to an external system.

The operations can further include receiving obstacle information about one or more obstacles between the launch point and the target. The operations can also include adjusting flight controls to compensate for a course deviation. The operations can further include detonating an explosive charge in the projectile casing at a predetermined time after firing the separation charge.

### BRIEF DESCRIPTION OF THE DRAWINGS

FIG. 1 is a diagram of an example projectile launched UAV reconnaissance system in accordance with at least one embodiment.

FIG. 2 is a diagram showing an example UAV projectile in accordance with at least one embodiment.

FIG. 3 is a diagram of an example UAV in rotor blade folded form in accordance with at least one embodiment.

FIG. 4 is a diagram of an example UAV with rotor blades unfolded in accordance with at least one embodiment.

FIG. 5 is a flow chart of an example method for projectile launched UAV reconnaissance system operation in accordance with at least one embodiment.

FIG. 6 is a diagram of an example projectile launched UAV reconnaissance repeater system in accordance with at least one embodiment.

FIG. 7 is a diagram of an example computer system configured for a projectile launched UAV reconnaissance system in accordance with at least one embodiment.

### DETAILED DESCRIPTION

In general, an embodiment can include a military, paramilitary and/or law enforcement intelligence UAV having opposing and counter rotating blades. The UAV can be configured for remote video surveillance. Also, the UAV can be delivered to a scene for observation via a projectile designed in the form factor of a 40 mm grenade cartridge, for example.

Some implementations include a UAV configured to provide tactical audio and video surveillance at a distance (e.g., 100 meters) in places having interference for direct observation (e.g., in buildings behind a wall, dense vegetation, or the like) or in places posing a risk to human presence.

In some implementations, the device consists of three units. The first unit is an unmanned surveillance system, the second is a system for managing the UAV, receiving video and transmitting the received video to another system, and the third is the projectile device for storage and delivery, which can be in the form factor of a standard 40 mm grenade cartridge (e.g., for use with a Heckler & Koch AG36 or an M203 grenade launcher).

In some implementations, an unmanned monitoring system can include an aircraft, in the form of a rotorcraft or the like—having one set of blades in an upper part of the device and a second set in the lower part of the device. The rotor blades can be made of a flexible and durable material (e.g., a plastic, a metal, a composite or the like) that provides the ability to store the blades when folded. At the same time, the blades can be configured to withstand multiple strikes from obstacles (e.g., tree branches, walls, and the like).

In some implementations, the system can include a flight control, navigation sensors, pressure sensor (wind), a wireless video reception/transmission module and video remote control, as well as a power supply (e.g., battery). The wireless module can be used as a “bridge” or repeater to neighboring UAVs and/or control systems, where direct radio contact may be difficult. Also, the UAV can be configured to withstand the axial forces associated with a launch from a grenade launcher or the like.

The control/monitoring system can include a launch conditions evaluation system, a GPS unit, a wireless module, a transceiver, a recording and storage device for received video, a control unit, a power supply and a display. The system can also include an encryption system to protect data and a unit for the verification of the video for future use as evidence for investigation, court proceedings or the like.

The system can also include a projectile storage and delivery unit that can be configured in the form factor of a 40 mm cartridge usable with an under-barrel grenade launcher, for example. The projectile unit can include a sleeve with a propelling charge and a payload section in which the UAV is stored. The role of the projectile unit is to ensure the safety of the UAV during storage, carrying, start-up launch and during the flight, as well as the delivery to a given point of the trajectory in a stable position. The projectile unit can have a payload section, a lifting charge or motor, a system for control of a response time of reaction of the charge, a stabilizer, an initiation block, and a battery. Also, to reduce shock on the UAV while the projectile accelerates to a required speed, a gunpowder engine (or other rocket motor or the like) can be used, rather than a propellant charge in the projectile cartridge.

An operator (e.g., human operator or computer system) can initiate the UAV system and produce a target indication, the system can estimate the time and conditions of starting the lifting charge, then send the data to all units (e.g., projectile, launcher and/or monitoring and control system). Next, the projectile is launched (e.g., fired from an under-barrel grenade launcher). After the projectile is launched, the projectile calculates the distance traveled and the trajectory. Prior to reaching a desired target location, and before the release of a separation charge, additional stabilization or course corrections signals can be received from the monitoring/control system or from an internal source and the flight trajectory can be adjusted, for example, by opening elements of the case or by releasing a brake band.

At the calculated point of the trajectory an expelling mechanism, such as a separation charge, mechanical expelling (or exiting, or discharging) mechanism, or other expelling mechanism is triggered or initiated, which causes the UAV to exit the body of the projectile unit and sends a force to the UAV back along the axis of motion in a rearward direction. The expelling mechanism gives the UAV an impulse sufficient to absorb some or all of the axial velocity, and possibly reduce axial velocity to zero. After the expelling mechanism acts, the UAV will be in a stable (or near stable) condition, sufficient to enter normal, post-discharge autonomous activity (e.g., the opening of the blades, maintaining the flight, and/or the like). This additional impulse is transmitted to the body of the projectile unit forward along the axis of motion and can be used to help propel the projectile unit to destroy minor obstacles in front (e.g., window panes, walls, barriers or the like). Stabilizing the UAV prior to the UAV initiating autonomous activity can be important because during the flight fairly strong acceleration and other forces can affect the container. It may be difficult to remove a fragile UAV from the container intact and at a pre-determined point. Thus, the expelling mechanism can both cause the UAV to exit the container and also provide a sufficient force so as to counteract the forces being experienced by the UAV during the launch trajectory.

Having been released from the projectile unit in a stable state, the UAV can deploy and start its engine (or other propulsion), stabilize its position in the air, transmit video or other signals and provide flight control of the device. Adjustments in flight can be made by an internal flight control unit with the sensor readings (e.g., maintaining proper attitude and/or avoiding the obstacles), using a guidance algorithm and/or the using commands from the monitoring/control unit. In the case of a weak signal, the monitoring/control unit may transmit a message to the operator signaling the need to start a second device in repeater mode.

Also, the arrangement of the blades can permit the use of the bottom blade as a stand for a touchdown in a place suitable for remote monitoring or support as a repeater.

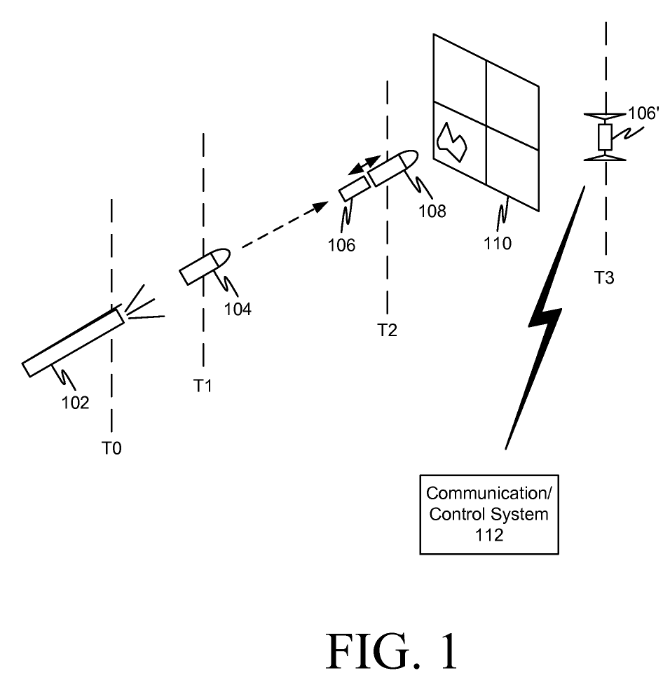

FIG. 1 is a diagram of an example projectile launched UAV reconnaissance system in accordance with at least one embodiment. The system includes a launcher 102 (e.g., an under barrel grenade launcher) and a projectile 104. The projectile includes a UAV payload 106 and an outer casing 108.

In operation, at time T0, the projectile 104 is launched from the launcher 102. At one or more times T1 during the flight, the projectile 104 may make course adjustments. At time T2, the projectile determines that a separation charge should be fired that will separate the UAV 106 from the projectile casing 108. The momentum of the charge slows the UAV 106 and can accelerate the casing 108 in order to break through an obstacle such as a window 110.

The UAV 106 can continue to fly through an opening created by the projectile casing 108. At time T3, the UAV may slow to a zero or near zero velocity at a desired target point in space and then deploy and begin to operate as a UAV 106′

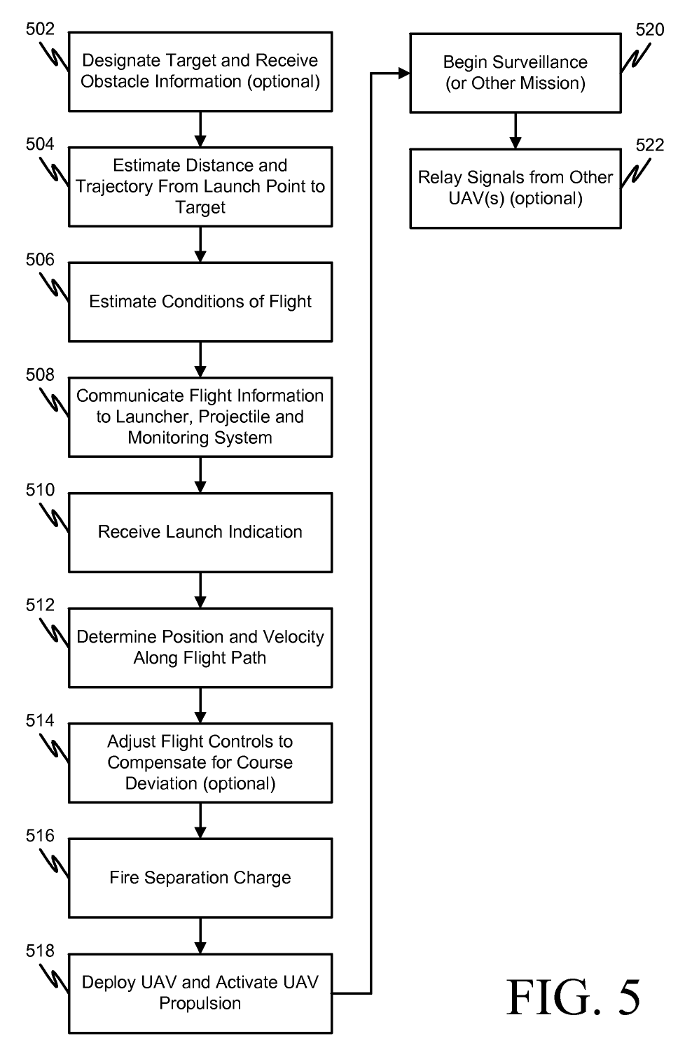

The deployed UAV 106′ can communicate with and/or receive control signals from a communication and control system 112. The communication and control system 112 can receive and store surveillance information (e.g., pictures, video, audio or other sensor signals) from the UAV 106′. The operation of the UAV and communication and control system is described in greater detail below in connection with FIG. 5.

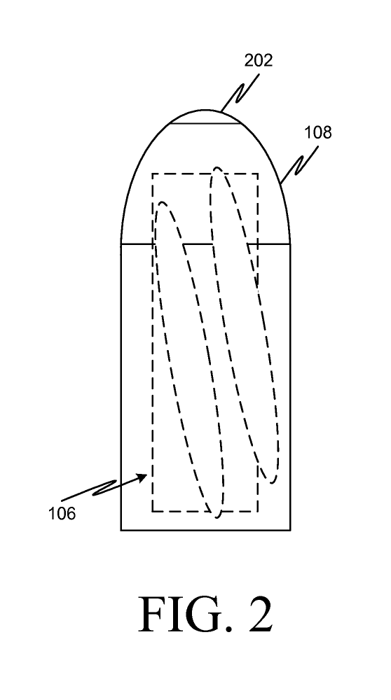

FIG. 2 is a diagram showing an example UAV projectile 104 having a projectile casing 108 and a UAV payload 106. Also, the projectile casing can include an explosive charge 202 in the tip of the projectile casing that can be detonated upon impact with an obstacle and used to help destroy or break through an obstacle in the path of the projectile casing 108. in accordance with at least one embodiment.

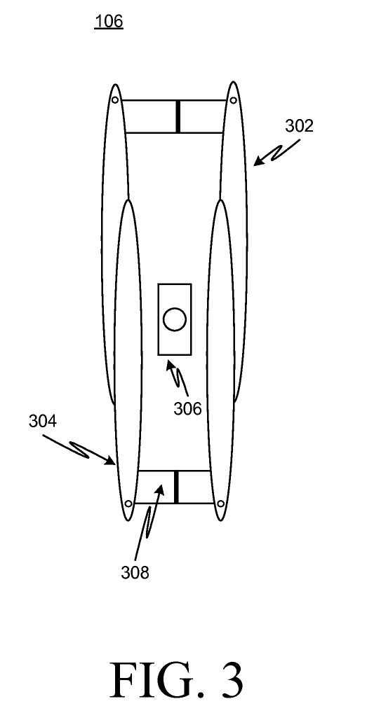

FIG. 3 is a diagram of an example UAV in rotor blade folded form in accordance with at least one embodiment. The UAV 106 includes an upper set of rotor blades 302, a lower set of rotor blades 304, a sensor 306 and a body portion 308. It will be appreciated that the UAV 106 can include more than one sensor and that the sensors can be arranged in location on the body portion 308 so as to provide the UAV 106 with an increased field of sensing.

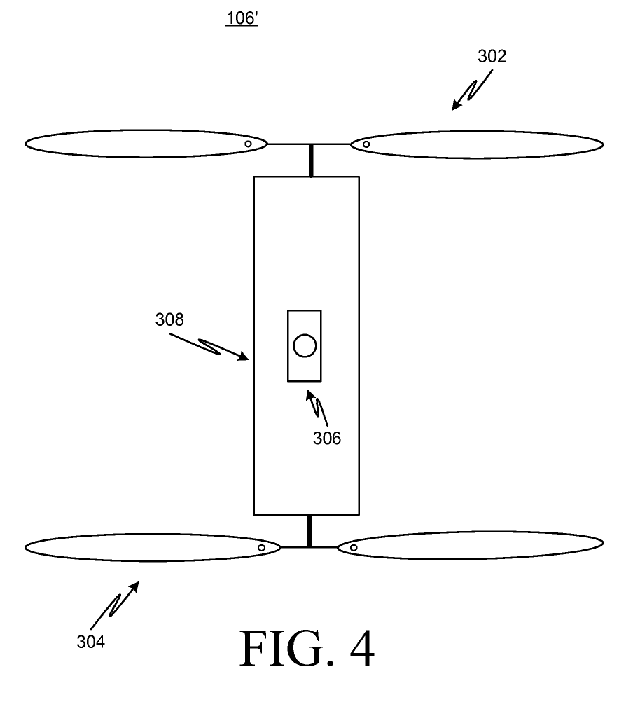

FIG. 4 is a diagram of an example UAV 106′ with rotor blades unfolded in accordance with at least one embodiment. The elements of FIG. 4 correspond to those described in connection with FIG. 3 above.

FIG. 5 is a flow chart of an example method for projectile launched UAV reconnaissance system operation in accordance with at least one embodiment. Processing begins at 502, where a target location is designated and obstacle information is optionally received. The target designation can come from an operator designated a target with a signal such as a laser or the like. The target designation can come from another system. Also, the target designation can include coordinates for a location in space. The obstacle information can include the type of obstacle (e.g., glass, wall, brush, or the like) and/or location of the obstacle (e.g., distance away from launch point). The type and location of the obstacle can be used by the system to determine a suitable method for using the projectile casing and/or explosive charge to remove the obstacle from the flight path of the UAV during launch phase. Processing continues to 504.

At 504, the system determines an estimated distance and/or trajectory from the launch point to the desired target location. Processing continues to 506.

At 506, the system can determine the conditions of flight (e.g., wind speed and direction, temperature, humidity or the like). Processing continues to 508.

At 508, the flight information (e.g., target location, flight trajectory, obstacle information and/or flight conditions) is communicated to the launcher, the projectile and the monitoring/control system. Processing continues to 510.

At 510, a launch indication is received. The projectile, launcher and monitoring/control system can receive the launch indication. For example, the launch indication can be received when a gunner fires the projectile from the launcher. Processing continues to 512.

At 512, the flight position, attitude and velocity are determined. Processing continues to 514.

At 514, flight controls are optionally adjusted to compensate for any course deviation or change in desired target location (e.g., a moving target). Flight controls can include passive components such as fins or other control surfaces. Also, flights controls can include active components such as rocket motors or explosive charges disposed on an outer surface of the projectile and configured to steer the projectile. Processing continues to 516.

At 516, the projectile detonates a separation charge. The separation charge can be configured to separate the UAV payload from the projectile casing. Also, the separation charge can be detonated at a time determined to help reduce or eliminate the axial velocity of the UAV and increase the axial velocity of the projectile casing to help the casing break through any obstacles in the flight path. Processing continues to 518.

At 518, once separated, the UAV can deploy flight mechanisms (e.g., rotor blades) and activate a propulsion system (e.g., fuel engine, electric motor or the like) and begin flight in the desired target area. Processing continues to 520.

At 520, the UAV can begin gathering data for surveillance and/or reconnaissance. Also, the UAV can hover in one location or fly a pattern under autonomous control and/or control from the communication and control unit. In addition to surveillance and/or reconnaissance, the UAV can also be equipped and configured for other missions such as search and rescue, combat, security, news reporting or, in general, any activity where a projectile launched UAV could be useful. Processing continues to 522.

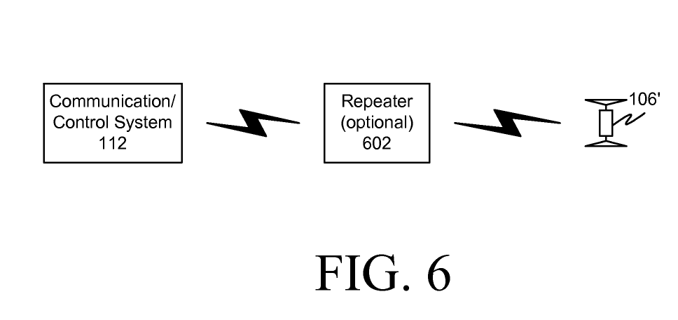

At 522, the UAV can relay signals for other UAV. For example, a first UAV may be operating in a location that has good radio contact with a monitoring and control system, while a second UAV is operating in a location that does not have good radio contact with the monitoring and control system. In this example, the first UAV can relay information from the second UAV to the monitoring and control system and vice versa. The relay scenario is shown in FIG. 6. It will be appreciated that 502-522 can be repeated in whole or in part in order to accomplish a projectile launched UAV task.

FIG. 6 is a diagram of an example projectile launched UAV reconnaissance repeater system in accordance with at least one embodiment. A UAV 106′ may need to communicate with a communication/control system 112, but may be out of radio range. A repeater 602 can be used to relay the signals being exchanged between the communication/control system 112 and the UAV 106′. The repeater can be another UAV in flight mode or landed, or the repeater can be a repeater that is stationary (after being delivered to the landing point).

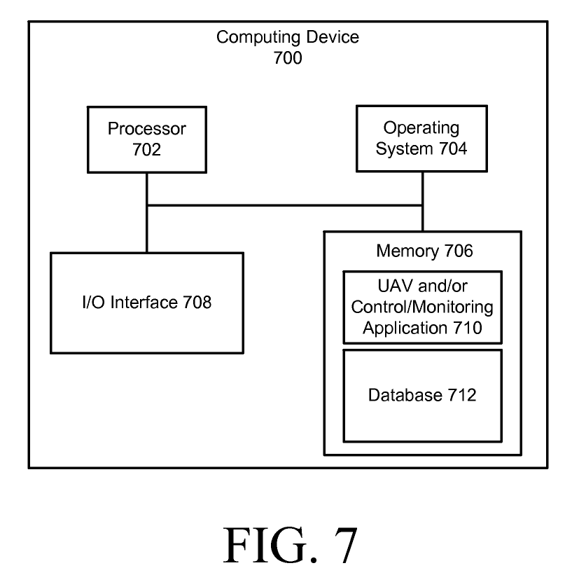

FIG. 7 is a diagram of an example computer system 700 in accordance with at least one implementation. The computer 700 includes a processor 702, operating system 704, memory 706 and I/O interface 708. The memory 706 can include a projectile UAV control and/or monitoring application 710 and a database 712.

In operation, the processor 702 may execute the application 710 stored in the memory 706. The application 710 can include software instructions that, when executed by the processor, cause the processor to perform operations for projectile UAV control and/or monitoring processing in accordance with the present disclosure (e.g., performing one or more of steps 502-522).

The application program 710 can operate in conjunction with the database 712 and the operating system 704.

It will be appreciated that the modules, processes, systems, and sections described above can be implemented in hardware, hardware programmed by software, software instructions stored on a nontransitory computer readable medium or a combination of the above. A projectile launched UAV reconnaissance system, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general purpose computer, a special purpose computer, a microprocessor, or the like.

It is, therefore, apparent that there is provided, in accordance with the various embodiments disclosed herein, a projectile launched UAV reconnaissance system including projectile UAV control and/or monitoring.

While the invention has been described in conjunction with a number of embodiments, it is evident that many alternatives, modifications and variations would be, or are, apparent to those of ordinary skill in the applicable arts. Accordingly, Applicant intends to embrace all such alternatives, modifications, equivalents and variations that are within the spirit and scope of the invention.

What is claimed is:

1. A method for a projectile launched UAV system, the method comprising:
determining a designated target for unmanned aerial vehicle (UAV) reconnaissance;
estimating a distance and trajectory from a launch point to the target;
communicating distance and trajectory information to a launcher, a projectile and a communication and control system;
receiving an indication that UAV projectile launch has occurred;
determining a position and a velocity of the UAV projectile along a flight path from the launch point to the target;
firing a separation charge when the UAV projectile reaches a predetermined point along the flight path, the separation charge being configured to separate a UAV from a projectile casing;
deploying the UAV and activating a propulsion system of the UAV;
obtaining signals via one or more sensors; and
transmitting the signals to an external system.

2. The method of claim 1, further comprising receiving obstacle information about one or more obstacles between the launch point and the target.

3. The method of claim 1, further comprising determining flight conditions including one or more of temperature, humidity, and wind speed and direction.

4. The method of claim 1, further comprising adjusting flight controls to compensate for a course deviation.

5. The method of claim 1, further comprising detonating an explosive charge in the projectile casing when the casing contacts an obstacle.

6. The method of claim 1, further comprising detonating an explosive charge in the projectile casing at a predetermined time after firing the separation charge.

7. The method of claim 1, wherein designating the target includes one or more of designating the target via a laser, designating the target with a signal, and receiving coordinates for the target.

8. The method of claim 1, further comprising relaying a signal from another UAV to a communication and control system.

9. A system comprising:
a processor coupled to a computer readable medium, the computer readable medium having stored thereon software instructions that, when executed by the processor, cause the processor to perform a series of operations, the operations including:
determining a designated target for unmanned aerial vehicle (UAV) reconnaissance;
estimating a distance and trajectory from a launch point to the target;
communicating distance and trajectory information to a launcher, a projectile and a communication and control system;
receiving an indication that UAV projectile launch has occurred;
determining a position and a velocity of the UAV projectile along a flight path from the launch point to the target;
firing a separation charge when the UAV projectile reaches a predetermined point along the flight path, the separation charge being configured to separate a UAV from a projectile casing;
deploying the UAV and activating a propulsion system of the UAV;
obtaining signals via one or more sensors; and
transmitting the signals to an external system.

10. The system of claim 9, wherein the operations further include receiving obstacle information about one or more obstacles between the launch point and the target.

11. The system of claim 9, wherein the operations further include determining flight conditions including one or more of temperature, humidity, and wind speed and direction.

12. The system of claim 9, wherein the operations further include adjusting flight controls to compensate for a course deviation.

13. The system of claim 9, wherein the operations further include detonating an explosive charge in the projectile casing when the casing contacts an obstacle.

14. The system of claim 9, wherein the operations further include detonating an explosive charge in the projectile casing at a predetermined time after firing the separation charge.

15. The system of claim 9, wherein designating the target includes one or more of designating the target via a laser, designating the target with a signal, and receiving coordinates for the target.

16. The system of claim 9, wherein the operations further include relaying a signal from another UAV to a communication and control system.

17. A nontransitory computer readable medium having stored thereon software instructions that, when executed by a processor, cause the processor to perform a series of operations including:
determining a designated target for unmanned aerial vehicle (UAV) reconnaissance;
estimating a distance and trajectory from a launch point to the target;
communicating distance and trajectory information to a launcher, a projectile and a communication and control system;
receiving an indication that UAV projectile launch has occurred;
determining a position and a velocity of the UAV projectile along a flight path from the launch point to the target;
initiating an expelling mechanism when the UAV projectile reaches a predetermined point along the flight path, the expelling mechanism being configured to separate a UAV from a projectile casing;
deploying the UAV and activating a propulsion system of the UAV;
obtaining signals via one or more sensors; and
transmitting the signals to an external system.

18. The nontransitory computer readable medium of claim 17, wherein the operations further include receiving obstacle information about one or more obstacles between the launch point and the target.

19. The nontransitory computer readable medium of claim 17, wherein the operations further include adjusting flight controls to compensate for a course deviation.

20. The nontransitory computer readable medium of claim 17, wherein the operations further include detonating an explosive charge in the projectile casing at a predetermined time after firing the separation charge.
